(19) United States
(12) Patent Application Publication
(10) Pub. No.: US 2003/0221521 A1
(43) Pub. Date: Dec. 4, 2003

(54) Ratchet tool having flat head

(76) Inventors: Tseng Shu-Ying, Taichung City (TW); Yu Hua-Rung, Taipei City (TW)

Correspondence Address: CHARLES E. BAXLEY ESQUIRE, Hart, Baxley, Daniels & Holton, 5 Fl., 59 John St., New York, NY, 10038, US

(21) Appl. No.: 10/159,479

(22) Filed: Jun. 3, 2002

(51) Int. Cl. B25B 13/00

(52) U.S. Cl. 81/58.5

(57) ABSTRACT

A ratchet tool includes a head having a hole for a driving member being engaged therewith and an open end in which an end of a handle is pivotably engaged. A cover plate is mounted to the head for retaining the driving member. Two sets of spring and bead are respectively installed in an underside of the cover plate and a surface of the head and the two beads are respectively engaged with two protrusions extending from two opposite sides of the end of the handle. A pawl is connected to the end of the handle and has two groups of engaging teeth no two ends thereof so to be alternatively engaged with the teeth in the driving member. The protrusions are forced to move over the two beads by pivoting the handle and two sides of the end of the handle contact against the two insides of the open end of the head so as to effectively drive the driving member.

### FIELD OF THE INVENTION

The present invention relates to a ratchet tool that has no protrusion extending from the head which is able to reach a narrow and deep position. The direction of rotation is changed by pivoting the handle.

### BACKGROUND OF THE INVENTION

A conventional ratchet tool generally includes a head with a handle extending therefrom and a driving member rotatably received in a hole defined in the head. A recess is defined in an inside of the hole and a bead and a spring are respectively received in the recess so that the bead is engaged with a pawl which has teeth to be engaged with the teeth defined in an outer periphery of the driving member in the head. A control member is connected to the pawl and extends from a surface of the head such that the user may operate the control member to change the position that the pawl is engaged with the driving member and the direction of rotation of the ratchet tool can be changed to output a torque to tighten or loosen an object such as a nut or a bolt. However, the control member extending from the head increases the thickness of the head and the head can not be inserted in a narrow area to reach the object. Furthermore, to drill a recess in the inside of the hole requires special tool which increases the manufacturing cost of the ratchet tool.

The present invention intends to provide a ratchet tool that chooses the direction of rotation by pivoting the handle.

### SUMMARY OF THE INVENTION

In accordance with one aspect of the present invention, there is provided a ratchet tool which comprises a head having a hole for a driving member being rotatably received therein and an open end. A first recess is defined in a surface in which the hole is defined and a first spring and a first bead are received in the first recess. A cover plate is mounted to the head and a second recess is defined in an underside thereof. A second spring and a second bead are received in the second recess.

A handle has an end pivotably received in the open end of the head and located between the cover plate and the head. Two protrusions extend from two opposite sides of the handle and are respectively engaged with the first bead and the second bead. A pawl is connected to the end of the handle and has two groups of engaging teeth which are engaged with teeth of the driving member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet tool of the present invention;

FIG. 2 shows the handle is pivoted to the left and the driving member is rotated with the tool clockwise;

FIG. 3 shows the handle is pivoted to the middle position which allows the head to be rotated counter clockwise while the driving member is remained still;

FIG. 4 shows the flexible plate is moved from a tip to a root of one of the teeth in the driving member when the handle is located at the middle position;

FIG. 5 shows that the handle is pivoted to the right and the driving member is rotated with the tool when the tool is rotated counter clockwise;

FIG. 6 shows the position relationship between the protrusions and the two beads when the handle is in the position as shown in FIG. 2;

FIG. 7 shows the position relationship between the protrusions and the two beads when the handle is rotated counter clockwise;

FIG. 8 shows the position relationship between the protrusions and the two beads when the handle is in the middle position, and

FIG. 9 is an exploded view to show that the pawl and the handle are made to be a one-piece member.

### DETAILED DESCRIPTION OF THE PREFERRED EMBODIMENT

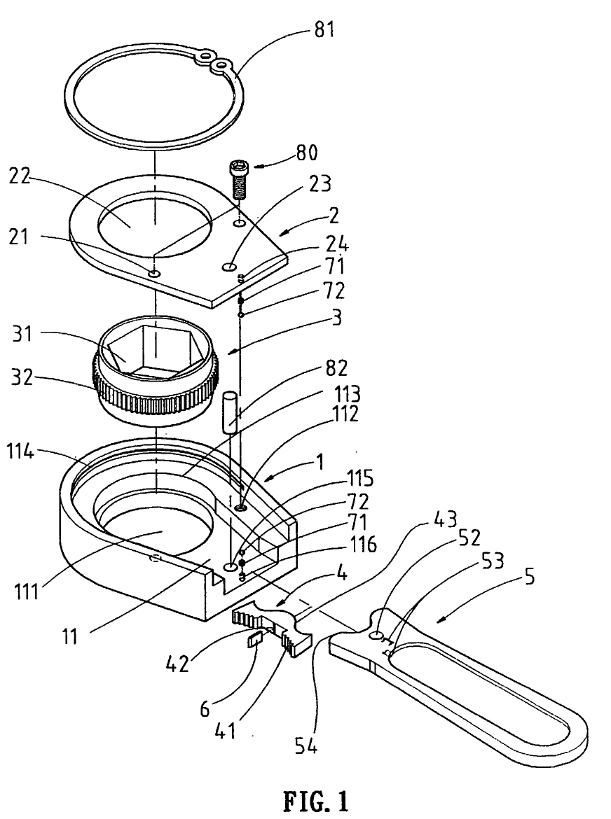

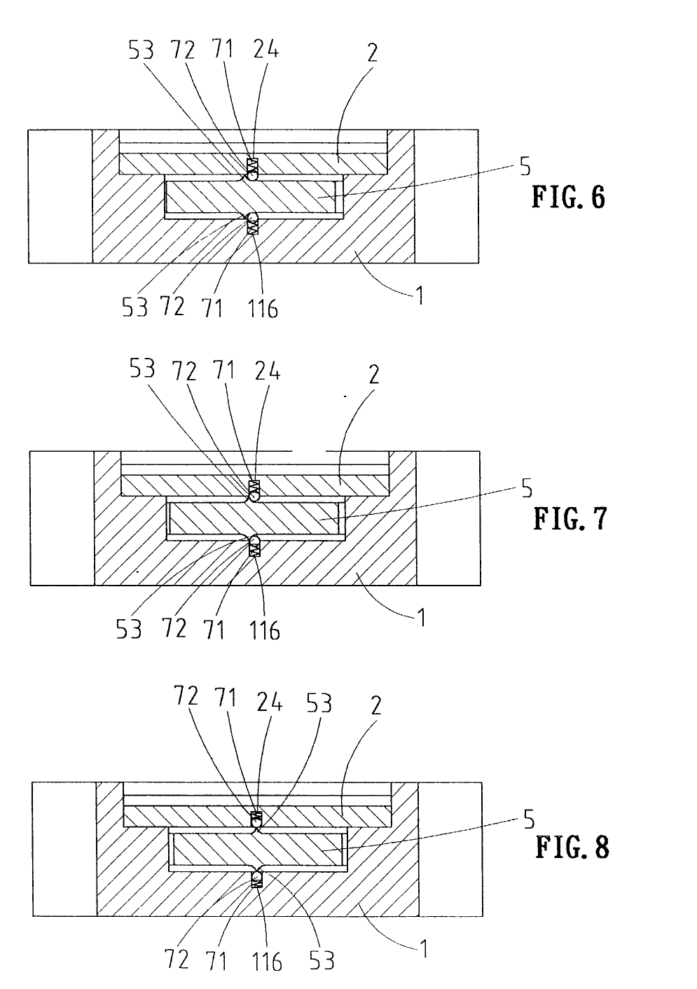

Referring to FIGS. 1, 2 and 6, the ratchet tool of the present invention comprises a head 1 having a hole 111 defined therethrough and an open end in which an end of a handle 5 is to be received. A first recess 116 is defined in a surface 11 in which the hole 111 is defined and a first spring 71 and a first bead 72 are received in the first recess 116. A U-shaped stepped surface 113 extends from the surface 11 in which the hole 111 is defined and has two threaded hole 112 so that a cover plate 2 is fixed on the stepped surface 113 by bolts 80 which extend through two holes 21 in the cover plate 2 and are threadedly engaged with the two threaded holes 112.

A driving member 3 is rotatably engaged with the hole 111 and has teeth 32 defined in an outer periphery of the driving member 3. A polygonal hoe 31 is defined through the driving member 3 so as to be mounted to an object with polygonal head. An end of the driving member 3 is received in the hole 111 of the head 1 and the other end of the driving member 3 is engaged with a hole 22 in the cover plate 2. A retaining ring 81 is mounted to the end of the driving member 3 extending through the hole 22 in the cover plate 2 and engaged in a groove 114 defined in an inside of the head 11. A second recess 24 is defined in an underside of the cover plate 2 and a second spring 71′ and a second bead 72′ are received in the second recess 24.

The end of the handle 5 is pivotably received in the open end of the head 1 and located between the cover plate 2 and the head 1 by extending a pin 82 through a hole 23 in the cover plate 2, a hole 52 in the handle 5 and a hole 115 defined in the surface 11 of the head 1. It is to be noted that the inner diameter of the hole 52 allows the pin 82 to be free rotated in the hole 52, and a width of the open end of the head 1 is wider than a width of the end of the handle 5. Two protrusions 53 extend from two opposite sides of the handle 5 and are respectively engaged with the first bead 72 and the second bead 72′. A recess 54 is defined in the end inserted in the open end of the head 1.

A pawl 4 has a convex 43 extending from a first end of the pawl 4 and the convex 43 is engaged with the recess 54 of the handle 5. Two groups of engaging teeth 41, 42 respectively extend from two ends of a second end of the pawl 4. One of the two groups of engaging teeth 41, 42 is engaged with the teeth 32 of the driving member 3. A flexible plate 6 is inserted in a slit 6 in an intermediate portion of the second end of the pawl 4 and engaged with the teeth 32 in the outer periphery of the driving member 3.

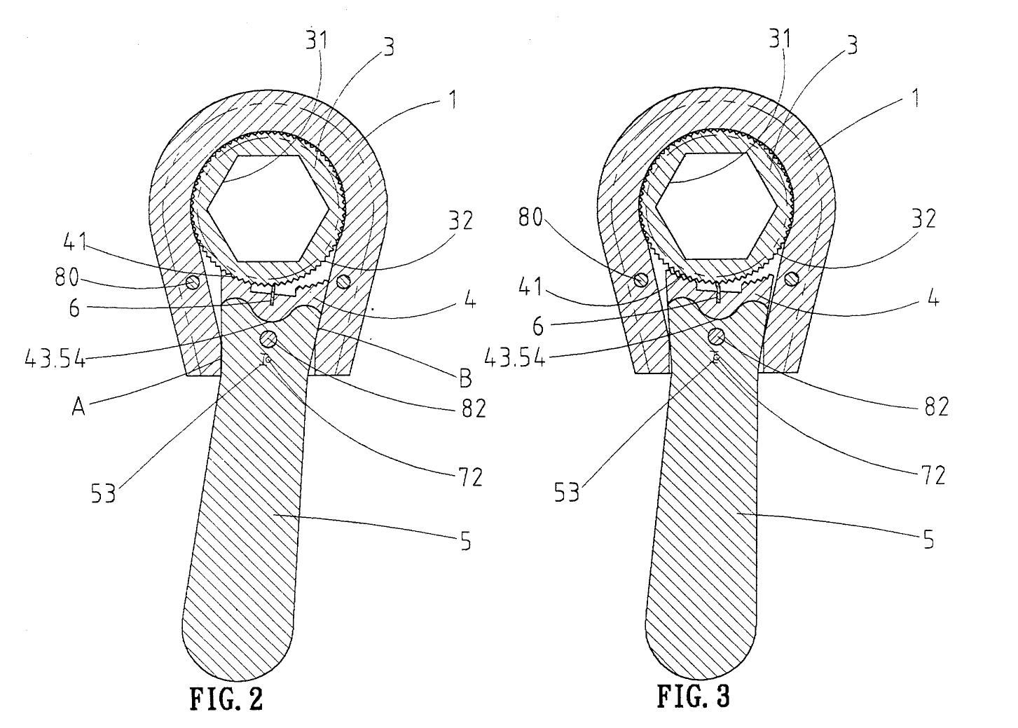

When the handle 5 is positioned at the left position as shown in FIG. 2, the two sides of the end of the handle 5 contact the insides of the open end of the head 1 at “A” and “B”, and only the engaging teeth 41 are engaged with the teeth 32 of the driving member 3. The driving member 3 is driven by the engagement of the engaging teeth 41 and the teeth 32 of the driving member 3 and rotated with the rotation of the handle 5 clockwise to output a torque to tighten or loosen an object.

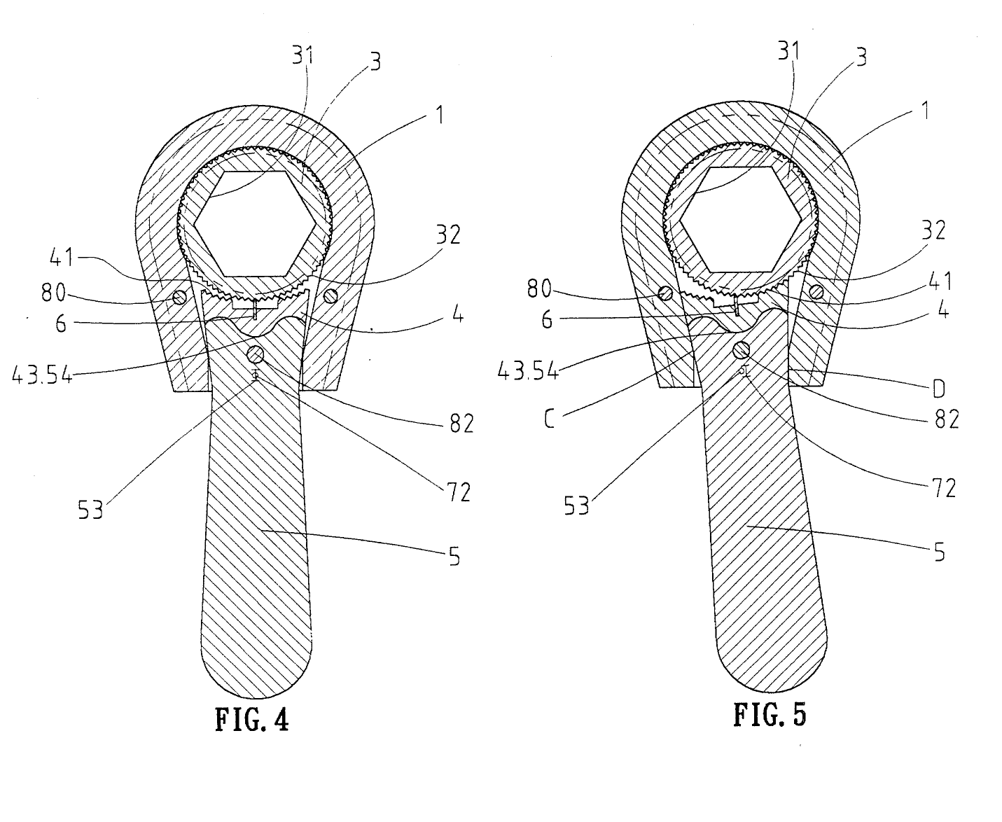

Referring to FIGS. 3, 4, 7 and 8, when rotating the handle 5 counter clockwise to a middle position, the engaging teeth 41 are disengaged from the teeth 32 of the driving member 3 which is not rotated when the tool is rotated counter clockwise. It is to be noted that the flexible plate 6 is moved from a root of one of the teeth 32 of the driving member 3 to a tip of the tooth 32 and then moves over the tooth 32 and drops to a root of the adjacent tooth 32 of the driving member 3 again. This generates sound of “click, click” when rotating the tool counter clockwise.

Referring to FIG. 5, when changing the direction of rotation of the tool, the user holds the head 1 and pivots the handle 5 to the right (counter clockwise) to force the protrusions 53 move over the two beads 72, 72′ and the two sides of the end of the handle 5 contact against the insides of the open end of the head 1 at positions “C” and “D”. The pawl 4 is also pivoted and the engaging teeth 42 are engaged with the teeth of the driving member 3. The driving member 3 is co-rotated with the rotation of the tool in counter clockwise. The head 1 has no protrusion extending from a top or the bottom so that the thickness of the head 1 is slim and is able to reach an object located in a deep and narrow area.

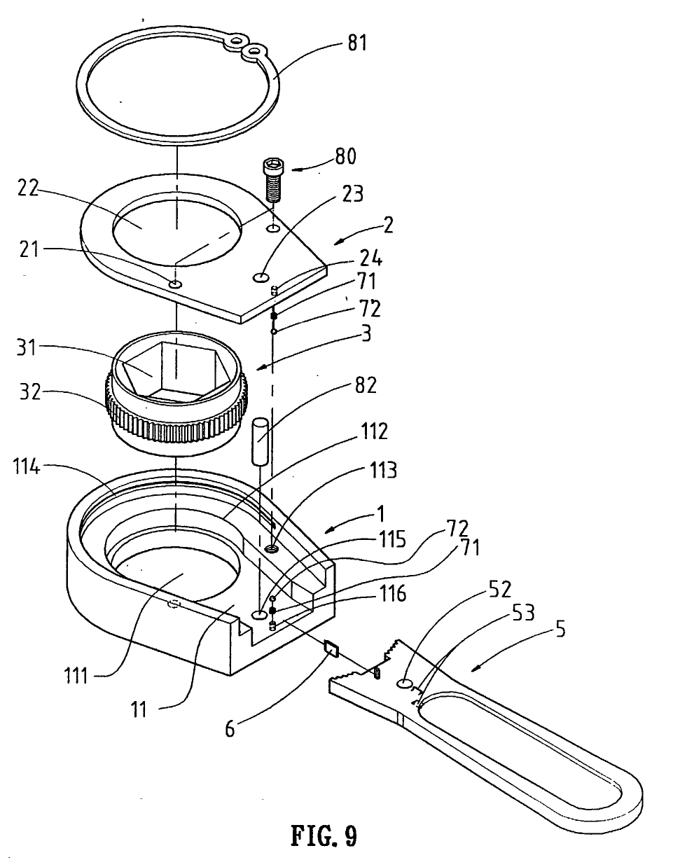

FIG. 9 shows that the pawl and the handle are made to be a one-piece member.

While we have shown and described the embodiment in accordance with the present invention, it should be clear to those skilled in the art that further embodiments may be made without departing from the scope of the present invention.

What is claimed is:

1. A ratchet tool comprising:
a head having a hole defined therethrough and an open end, a first recess defined in a surface in which the hole is defined and a first spring and a first bead being received in the first recess, a driving member rotatably engaged with the hole and having teeth defined in an outer periphery of the driving member, a cover plate mounted to the head and a second recess defined in an underside thereof, a second spring and a second bead being received in the second recess;
a handle having an end pivotably received in the open end of the head and located between the cover plate and the head by a pin, two protrusions extending from two opposite sides of the handle and respectively engaged with the first bead and the second bead, and
a pawl having a first end engaged with the end of the handle and two groups of engaging teeth respectively extending from two ends of a second end of the pawl, one of the two groups of engaging teeth being engaged with the teeth of the driving member.

2. The ratchet tool as claimed in claim 1, wherein and a U-shaped stepped surface extends from the surface in which the hole is defined and the cover plate is fixed on the stepped surface.

3. The ratchet tool as claimed in claim 1 further comprising a recess defined in the end inserted in the open end of the head and a convex extending from the first end of the pawl, the convex engaged with the recess

4. The ratchet tool as claimed in claim 1 further comprising a flexible plate extending from an intermediate portion of the second end of the pawl and engaged with the teeth in the outer periphery of the driving member.

5. The ratchet tool as claimed in claim 1 wherein a width of the open end of the head is wider than a width of the end of the handle.
